(19) United States
(12) Patent Application Publication
(10) Pub. No.: US 2017/0300441 A1
(43) Pub. Date: Oct. 19, 2017

(54) HDMI AND DP COMPATIBLE INTERFACE CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: TAI-CHEN WANG, New Taipei (TW); JUN SUN, Wuhan (CN)

(21) Appl. No.: 15/151,148

(22) Filed: May 10, 2016

(30) Foreign Application Priority Data
Apr. 14, 2016 (CN) 201610229990.5

(51) Int. Cl. G06F 13/38; G06F 13/42; G06F 13/40

(52) U.S. Cl. CPC G06F 13/385; G06F 13/4022; G06F 13/4282

(57) ABSTRACT

An interface circuit providing compatibility between HDMI and DP display devices includes a interface, a signal transmitting chip, and a signal transmitting control unit. The interface can couple to a HDMI device or a DP device. The signal transmitting control unit is coupled to the interface and the signal transmitting chip. The signal transmitting control unit automatically couples the interface to different pins of the signal transmitting chip when the interface is coupled to different display devices.

### CROSS-REFERENCE TO RELATED APPLICATIONS

This application claims priority to Chinese Patent Application No. 201610229990.5 filed on Apr. 14, 2016, the contents of which are incorporated by reference herein.

### FIELD

The subject matter herein relates to interfaces between devices, and more particularly to a HDMI and DP compatible interface circuit.

### BACKGROUND

In computer or media system having a source unit coupled to a display device by a cable, a video output is provided to the display device. One known technique for providing video output to the display device is to use one DP (“Display Port”) cable and pair of connectors to couple video signals and associated video timing signals from the source unit to the display device. Another known technique for providing video output at the location of the display device is to follow the HDMI (“High-Definition Multimedia Interface”) standard. For a conventional electronic apparatus, the DP connector and the HDMI connector are, physically and as a matter of protocol, different standards. The expense of including both types of connection (DP and HDMI) is high.

### BRIEF DESCRIPTION OF THE DRAWINGS

Implementations of the present technology will now be described, by way of example only, with reference to the attached figures.

FIG. 1 is a block diagram of an embodiment of a HDMI and DP-compatible interface circuit.

FIG. 2 is a circuit diagram of the HDMI and DP-compatible interface circuit of FIG. 1.

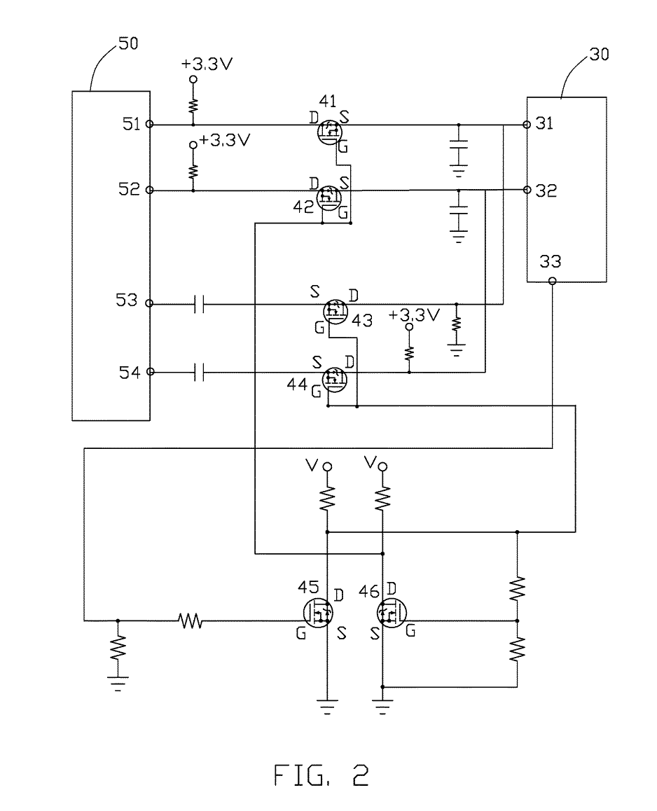

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

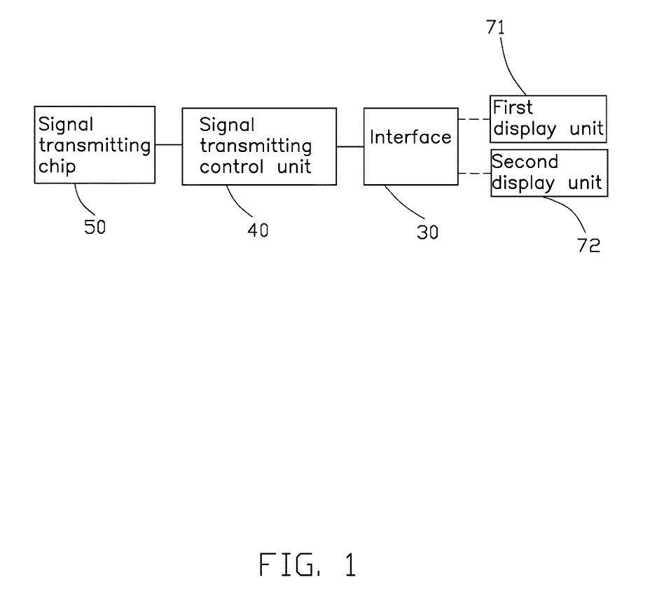

FIG. 1 illustrates a HDMI and DP-compatible interface circuit in accordance with an embodiment. The HDMI and DP-compatible interface circuit includes an interface 30, a signal transmitting control unit 40, and a signal transmitting chip 50. The interface 30 can connect to a HDMI cable or a DP cable. In one embodiment, the interface 30 is a conventional HDMI port, which has nineteen pins. A first display unit 71 complying with HDMI standard can be connected to the interface 30 via a HDMI cable. A second display unit 72 complying with DP standard can be connected to the interface 30 via a DP cable.

FIG. 1 illustrates the HDMI and DP-compatible interface circuit of FIG. 1. The interface 30 includes a data pin 31, a timing pin 32, and a HDMI device detection pin 33. The data pin 31 transmits video signal. The timing pin 32 transmits timing signal. The HDMI device detection pin 33 detects whether there is a HDMI device connected to the interface 30. When there is a HDMI device connected to the interface 30, a voltage on the HDMI device detection pin 33 is high. When there is no device or only a DP device connected to the interface 30, a voltage on the HDMI device detection pin 33 is low.

The signal transmitting chip 50 includes a HDMI signal data pin 51, a HDMI signal timing pin 52, a DP signal data pin 53, and a DP signal timing pin 54.

The signal transmitting control unit 40 includes six switches. In one embodiment, the six switches are six field-effect transistors: a first transistor 41, a second transistor 42, a third transistor 43, a fourth transistor 44, a fifth transistor 45, and a sixth transistor 46. The six transistors 41 to 46 are N channel field-effect transistors.

A first transistor source is coupled to the data pin 31 of the interface 30. A first transistor drain is coupled to the HDMI signal data pin 51. A second transistor source is coupled to the timing pin 32 of the interface 30. A second transistor drain is coupled to the HDMI signal timing pin 52. A third transistor source is coupled to the DP signal data pin 53. A third transistor drain is coupled to the data pin 31. A fourth transistor source is coupled to the DP signal timing pin 54. A fourth transistor drain is coupled to the timing pin 32.

A fifth transistor gate is coupled to the HDMI device detection pin 33. A fifth transistor source is grounded. A fifth transistor drain is coupled to a high level voltage source V via a first resistor, and further coupled to the third transistor gate and the fourth transistor gate. A sixth transistor gate is coupled to the fifth transistor drain via a second resistor. A sixth transistor drain is coupled to the high level voltage source V, and further coupled to the first transistor gate of and the second transistor gate. A sixth transistor source is grounded.

In working, when the interface 30 does not connect to any device, the HDMI device detection pin 33 is in low level. The fifth transistor 45 is turned off. A voltage on the fifth transistor drain is in high level to turn on the third transistor 43, the fourth transistor 44, and the sixth transistor 46. The sixth transistor drain is in low level to turn off the first transistor 41 and the second transistor 42.

When the interface 30 connects to the second display unit 72 complying with DP standard, the HDMI device detection pin 33 is kept in low level. Thus, the data pin 31 is coupled to the DP signal data pin 53 via the third transistor 43, and the timing pin 32 is coupled to the DP signal timing pin 54 via the fourth transistor 44. The DP signal is transmitted between the interface 30 and the signal transmitting chip 50.

When the interface 30 connects to the first display unit 71 complying with HDMI standard, the HDMI device detection pin 33 is in high level. The fifth transistor 45 is turned on. A voltage on the fifth transistor drain is in low level to turn off the third transistor 43, the fourth transistor 44, and the sixth transistor 46. A voltage on the sixth transistor drain is in high level to turn on the first transistor 41 and the second transistor 42. Thus, the data pin 31 is coupled to the HDMI signal data pin 51 via the first transistor 41, and the timing pin 32 is coupled to the HDMI signal timing pin 52 via the second transistor 42. The HDMI signal is transmitted between the interface 30 and the signal transmitting chip 50.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A HDMI and DP compatible interface circuit, comprising:
an interface configured to couple a HDMI device or a DP device;
a signal transmitting chip; and
a signal transmitting control unit coupled to the interface and the signal transmitting chip, wherein the signal transmitting control unit is configured to couple the interface to different pins of the signal transmitting chip when the interface is coupled to different devices.

2. The HDMI and DP compatible interface circuit of claim 1, wherein the interface comprises a data pin, the signal transmitting chip comprises a HDMI signal data pin and a DP signal data pin, and the HDMI signal data pin and the DP signal data pin are coupled to the data pin of the interface via the signal transmitting control unit.

3. The HDMI and DP compatible interface circuit of claim 2, wherein the signal transmitting control unit comprises a first transistor and a third transistor, a first transistor source is coupled to the data pin of the interface, a first transistor drain is coupled to the HDMI signal data pin, a third transistor source is coupled to the DP signal data pin, and a third transistor drain is coupled to the data pin of the interface.

4. The HDMI and DP compatible interface circuit of claim 3, wherein the interface further comprises a HDMI device detection pin, the signal transmitting control unit comprises a fifth transistor and a sixth transistor, a fifth transistor gate is coupled to the HDMI device detection pin, a fifth transistor source is grounded, a fifth transistor drain is coupled to a high level voltage source via a first resistor, and further coupled to a third transistor gate, a sixth transistor gate is coupled to the fifth transistor drain via a second resistor, a sixth transistor drain is coupled to the high level voltage source, and further coupled to the first transistor gate, and a sixth transistor source is grounded.

5. The HDMI and DP compatible interface circuit of claim 4, wherein the HDMI device detection pin has different level voltage when the interface is couple the HDMI device or the DP device.

6. The HDMI and DP compatible interface circuit of claim 5, wherein the HDMI device detection pin has high level voltage when the interface is couple the HDMI device, and has low level voltage when the interface is coupled to the DP device.

7. The HDMI and DP compatible interface circuit of claim 6, wherein the HDMI device detection pin has low level voltage when there is no device connected to the interface.

8. The HDMI and DP compatible interface circuit of claim 2, wherein the interface comprises a timing pin, the signal transmitting chip comprises a HDMI signal timing pin and a DP signal timing pin, and the HDMI signal timing pin and the DP signal timing pin are coupled to the timing pin of the interface via the signal transmitting control unit.

9. A compatible interface circuit, comprising:
an interface;
a signal transmitting chip; and
a signal transmitting control unit coupled to the interface and the signal transmitting chip, wherein the signal transmitting control unit is configured to couple the interface to different pins of the signal transmitting chip when the interface is coupled to different devices.

10. The compatible interface circuit of claim 9, wherein the interface comprises a data pin, the signal transmitting chip comprises a HDMI signal data pin and a DP signal data pin, and the HDMI signal data pin and the DP signal data pin are coupled to the data pin of the interface via the signal transmitting control unit.

11. The compatible interface circuit of claim 10, wherein the signal transmitting control unit comprises a first transistor and a third transistor, a first transistor source is coupled to the data pin of the interface, a first transistor drain is coupled to the HDMI signal data pin, a third transistor source is coupled to the DP signal data pin, and a third transistor drain is coupled to the data pin of the interface.

12. The compatible interface circuit of claim 11, wherein the interface further comprises a HDMI device detection pin, the signal transmitting control unit comprises a fifth transistor and a sixth transistor, a fifth transistor gate is coupled to the HDMI device detection pin, a fifth transistor source is grounded, a fifth transistor drain is coupled to a high level voltage source via a first resistor, and further coupled to a third transistor gate, a sixth transistor gate is coupled to the fifth transistor drain via a second resistor, a sixth transistor drain is coupled to the high level voltage source, and further coupled to the first transistor gate, and a sixth transistor source is grounded.

13. The compatible interface circuit of claim 12, wherein the HDMI device detection pin has different level voltage when the interface is couple the HDMI device or the DP device.

14. The compatible interface circuit of claim 13, wherein the HDMI device detection pin has high level voltage when the interface is couple the HDMI device, and has low level voltage when the interface is coupled to the DP device.

15. The compatible interface circuit of claim 14, wherein the HDMI device detection pin has low level voltage when there is no device connected to the interface.

16. The compatible interface circuit of claim 10, wherein the interface comprises a timing pin, the signal transmitting chip comprises a HDMI signal timing pin and a DP signal timing pin, and the HDMI signal timing pin and the DP signal timing pin are coupled to the timing pin of the interface via the signal transmitting control unit.
